(19) United States
(12) Patent Application Publication
(10) Pub. No.: US 2005/0058031 A1
(43) Pub. Date: Mar. 17, 2005

(54) Optical disk drive focusing apparatus

(76) Inventor: Darwin Mitchel Hanks, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/661,752

(22) Filed: Sep. 12, 2003

(51) Int. Cl. G11B 7/095

(52) U.S. Cl. 369/44.29; 369/44.41

(57) ABSTRACT

A system, for providing an actuator control signal to an actuator within an optical pickup unit of an optical disk drive, focuses optics on an optical disk. In one implementation, an error term is obtained by sampling the FES (focus error signal) signal. The error term is scaled by an adaptation coefficient, which regulates a rate at which the error term modifies the actuator control signal. An actuator control signal generator generates the actuator control signal to control movement of the actuator, wherein the actuator control signal is a function of a prior actuator position, the error signal and the adaptation coefficient.

### RELATED APPLICATIONS

This patent application is related to U.S. patent application Ser. No. ______, titled “Optical Disk Drive Focusing Apparatus”, filed on even day herewith, commonly assigned herewith, and hereby incorporated by reference.

### BACKGROUND

When reading or writing data to the data side of a CD, conventional use of a FES (focus error signal) provides information that allows operation of a closed-loop feedback circuit to keep the optical pickup unit (OPU) focused on the data pits defined on an upper surface of a plastic layer.

However, emerging technology makes it possible to write to the label side of the CD, thereby producing an image, text and/or graphics. Unfortunately, conventional use of a FES to focus on the label side of the disk is ineffective.

An initial difficulty in focusing on the label side of the disk is that the FES signal provides a low signal-to-noise ratio, in part due to the nature of the media used to cover the label side of the disk. Because of the low signal-to-noise ratio, conventional use of a FES signal configured in a closed-loop feedback circuit will not effectively provide signals to the actuator focus coil which result in convergence on the intended focal point, i.e. the surface of the disk.

A second difficulty in using the FES signal in a conventional manner is that the OPU is configured to have an at-rest focal point that is further from the laser and optics than the surface of the label side of the disk. This is because the OPU is designed to focus on data pits defined within the optical disk, approximately 1.2 mm from the surface of the data side of the disk. Thus, the laser and optics are out-of-focus when in the at-rest position.

Additionally, tilting of the disk within the optical disk drive and variances in the thickness of the disk produce focus errors that tend to appear as a sinusoidal variation once per revolution of the disk. Similarly, warping of the disk creates focus errors that may appear as a sinusoidal variation twice per revolution. Without an effective closed-loop feedback circuit, these sources of focus error can result in much degraded performance when marking an image to the label side of a disk.

As a result, new and improved systems and methods of focusing the OPU on the label side are needed.

### SUMMARY

A system, for providing an actuator control signal to an actuator within an optical pickup unit of an optical disk drive, focuses optics on an optical disk. In one implementation, an error term is obtained by sampling the FES (focus error signal) signal. The error term is scaled by an adaptation coefficient, which regulates a rate at which the error term modifies the actuator control signal. An actuator control signal generator generates the actuator control signal to control movement of the actuator, wherein the actuator control signal is a function of a prior actuator position, the error signal and the adaptation coefficient.

### BRIEF DESCRIPTION OF THE DRAWINGS

The following detailed description refers to the accompanying figures. In the figures, the left-most digit(s) of a reference number identifies the figure (FIG.) in which the reference number first appears. Moreover, the same reference numbers are used throughout the drawings to reference like features and components.

FIG. 1 is a diagrammatic view of an exemplary implementation of an optical disk drive.

FIG. 2 is a block diagram showing an exemplary implementation of a feed forward engine contained within firmware of the diagrammatic view of the optical disk drive of FIG. 1.

FIG. 3 is a view of an optical disk, illustrating exemplary division of the disk into a plurality of sectors.

FIG. 4 is a block diagram showing an exemplary implementation of portions of the feed forward engine.

FIG. 5 is a flow diagram illustrating an exemplary implementation focusing optics within an optical drive.

FIG. 6 is a diagrammatic view of a quad sensor, illustrating an in-focus condition.

FIGS. 7 and 8 are diagrams similar to that of FIG. 6, in which the quad sensor detects out-of-focus conditions wherein the optics focus too close and too far, relative to the focal point.

### DETAILED DESCRIPTION

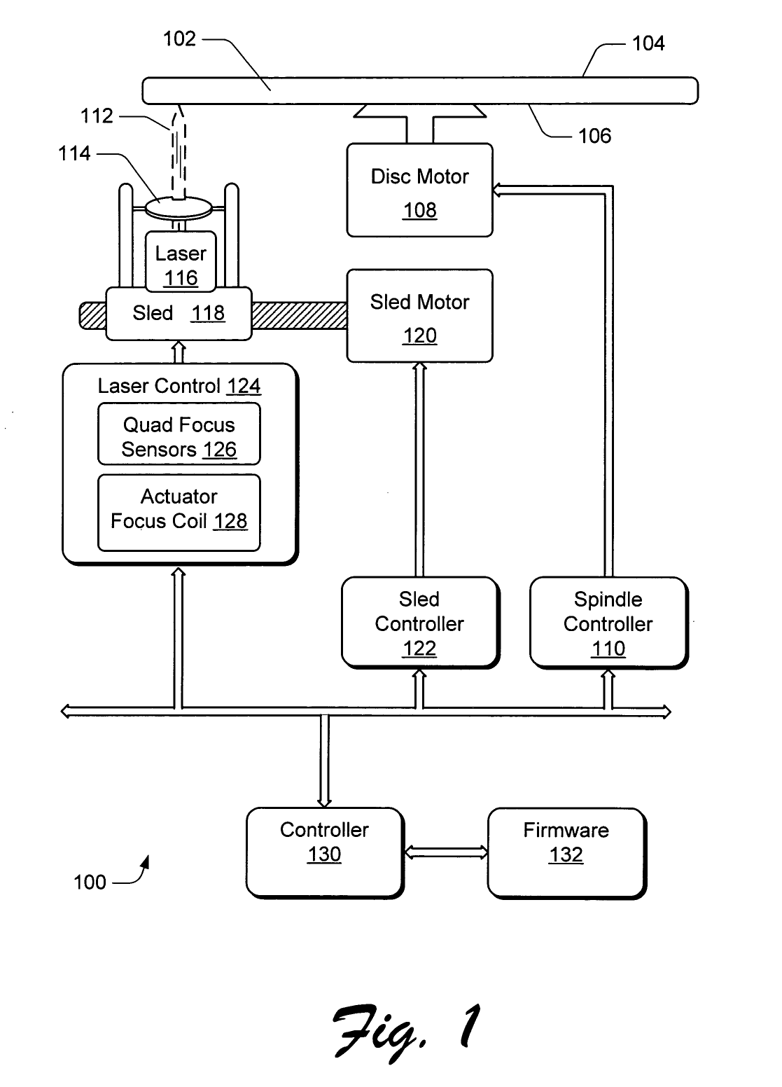

FIG. 1 shows a somewhat diagrammatic view of an exemplary disk drive and controller system 100. A disk 102 having an information side 104 is oriented to position a label side 106 for marking. The disk is rotated by a disk or spindle motor 108, which is controlled by a spindle controller 110. A laser beam 112 strikes a coated surface of the label side 106 of the disk 102 after passing through optics, such as a lens 114. A laser 116 is carried by a sled 118, which is moved in a radial direction by a sled motor 120. In a typical application, the sled motor 120 advances the sled 118, carrying the laser 116, in incremental steps from a radially inner edge of the label region, to a radially outer edge of the label region under the direction of a sled controller 122.

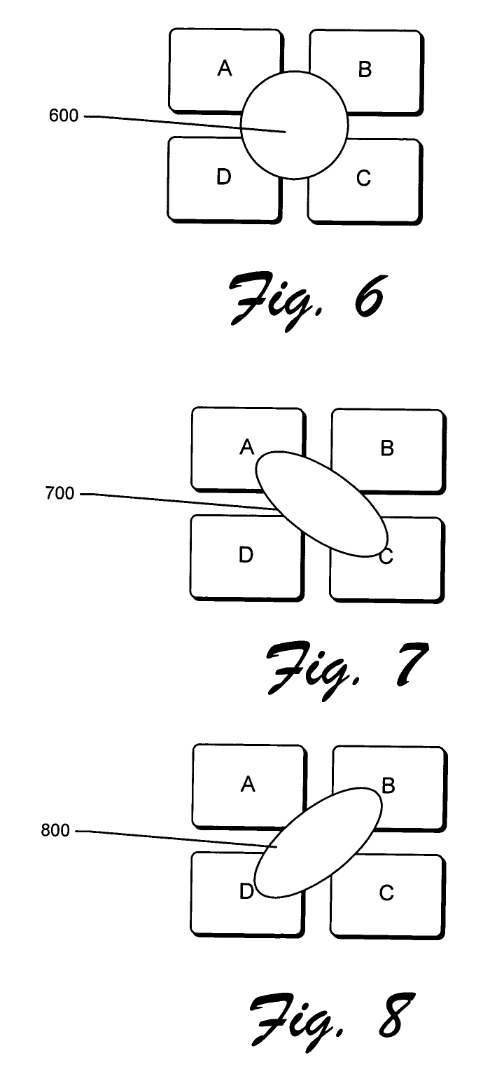

A laser controller 124 controls the operation of the laser 116 and associated tracking coils and sensors. In the example of FIG. 1, a quad focus sensor 126 typically contains four sensors, and is designed to facilitate focusing generally, in part by sensing the distance between the laser and the disk. The operation of the quad focus sensors may be understood with reference to FIGS. 6-8. In FIG. 6, the four quad sensors, labeled A-D are seen. The output of the quad sensors may be used to form both the FES (focus error signal) and the SUM signal. The FES signal is defined: FES=(V_{A}+V_{C})−(V_{B}+V_{D}), wherein V_{A} is the voltage of sensor A, etc. The SUM signal is defined: SUM=V_{A}+V_{B}+V_{C}+V_{D}. Reflected light 700 is seen in a generally circular configuration, which implies that each sensor is similarly affected. Accordingly, the FES signal is approximately zero (0) volts. FIGS. 7 and 8 illustrate conditions wherein the reflected light 800, 900 indicates that the optics is in front of, and behind, the focal point. The outputs of the four sensors are combined to form the SUM signal, (or the difference of the diagonals is used to form the FES signal), both of which are discussed below. An actuator focus coil 128 is configured to adjust the optics 114 to focus the laser 116 at points both toward and away from, the disk 102.

A controller 130 controls the operation of the exemplary disk drive and controller system 100. In particular, the controller 130 is configured to execute program statements such as those contained in firmware 132.

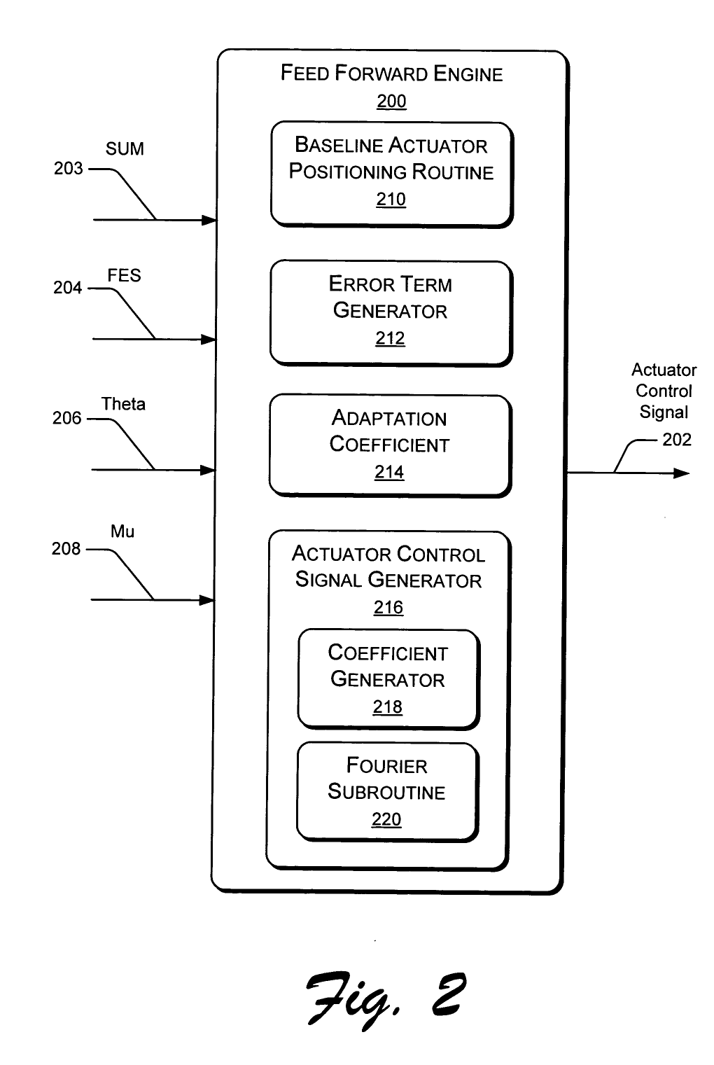

FIG. 2 shows an exemplary feed forward engine 200, which may be defined by program statements contained within firmware 132 for execution by the processor or controller 130. The feed forward engine 200 receives one or more inputs and provides as output an actuator control signal 202, which can be fed into the actuator focus coil 128 (FIG. 1) to control the focus of the laser 116, optics 114 and associated assembly. The exemplary feed forward engine 200 receives inputs including a FES (focus error signal) signal 204 from the quad focus sensors 126 (FIG. 1), the SUM signal 203 (also from the quad focus sensors) and an angle theta 206 which describes the angular orientation of the disk 102 (FIG. 1) within the optical drive 100 (FIG. 1). In some implementations, a coefficient Mu 208 is also provided to the feed forward engine. As will be seen in greater detail below, the coefficient Mu balances a rate at which the FES signal 204 is used to modify a current voltage applied to the actuator focus coil 128. This is important, in part because the FES signal is typically fairly noisy, when used to focus on the label side 106 of the disk 102. In part because the FES signal was not intended for use in focusing the laser optics on the label side 106 of the disk 102, the standard approach of using a high bandwidth feedback loop does not work well. Accordingly, the FES signal is scaled by one or more factors, such as Mu. The value of the Mu input 208 may be more fully understood by realizing that if the FES signal is allowed to overly influence a present value of the voltage input to the actuator coil 128, the actuator coil 128 may swing too wildly and fail to converge, i.e. focus the laser on the label surface 106 of the disk. This is due in large part to the differences encountered when focusing on the coating on the surface 106 of the disk 102, rather than on data pits defined within the interior of the disk, as is conventionally done. In a worst case situation, if Mu were not used to damp changes brought on by wild swings in the value of the FES signal, the focal point may leave a region within which the FES signal may be detected; this could cause a complete failure to focus. However, if the FES signal is overly suppressed from influencing the present value of the voltage input to the actuator coil 128, the laser may not respond quickly enough to changing conditions, and may fail to focus. Accordingly, the value of Mu input 208 should be selected according to the specific application to result in proper focus.

A baseline actuator positioning routine 210 is configured to determine a baseline voltage level for application to the actuator focus coil 128, to result in an associated baseline actuator position and focus optics position on the surface 106 of the disk 102. The actuator 128 has an inherent, initial or at-rest position, which may reflect an inherent or default voltage applied to the coil, or which may reflect the coil being allowed to “float” at an initial voltage level. As a result, the focal optics moved by the actuator have an inherent, default or at-rest focal point. In part because the optics 114 are designed to focus on a location within the disk, the at-rest position of the actuator 128 and optics 114 is typically too close to the disk to result in proper focus on the disk surface 106 without application of a signal to the actuator 128. As a result, it is beneficial to establish a baseline voltage, the application of which to the actuator coil 128 results in approximate focusing of the optics 114 on the surface 106 of the disk 102. Accordingly, the baseline actuator positioning routine 210 determines the baseline voltage level. It is sometimes the case that the baseline voltage has an AC component, i.e. the baseline voltage may vary as a function of the angular orientation (i.e. the spin) of the disk. Such an AC component can vary according to the sectors of FIG. 3, or as a function of the angular disk orientation. Such an AC component allows the baseline voltage to vary the actuator focus coil 128 to maintain the focus of the optics 114 on the surface 106 of the disk 102, even where the disk is warped, wedge-shaped, or otherwise imperfect.

In a first exemplary implementation, the baseline actuator positioning routine 210 is configured to apply an initial voltage to the actuator coil 128 to move the focal point of the optics 114 away from the disk 102 (FIG. 1) by an amount calculated to counteract an initial design assumption typically built into the actuator coil. The design assumption is that the focus point should be inside the plastic disk 102, to facilitate data reading and writing. However for labeling the disk, the focus point should be on the disk surface. Accordingly, a baseline voltage may be estimated to result in movement of the actuator coil 128, and an associated change in the focal point of the optics 114, which retracts the focal point by an appropriate fraction of the thickness of the optical disk 102, thereby causing the focal point to be (approximately) on the surface 106 of the disk 102.

The above first exemplary implementation of the baseline positioning routine 210 makes a first assumption that the optics 114, is focused on a point a known depth beneath the surface 106 of the disk 102, and a second assumption that a voltage can be calculated to move the focal point to the surface of the disk. A second implementation of the baseline positioning routine 210 is based on the use of objective measurements. The baseline actuator positioning routine 210 is configured to move the optics 114 through a full range of focus, i.e. from focusing too near to focusing too far away. The baseline actuator positioning routine 210 is configured to step the actuator coil 128 through this range incrementally, and to record values obtained from the SUM. Upon completion of the application of the range of voltages to the actuator coil 128, and movement of the focus optics, the maximum value of the SUM signal is recorded. This value may be assumed to have occurred when the optics was approximately in focus; additionally, the voltage which resulted in the position of the optics may be taken as the baseline voltage.

Alternatively, to cancel some inaccuracies within the operation of the actuator focus coil 128, DC voltage may again be stepped incrementally into the actuator focus coil to move the optics 114 until the SUM signal is approximately 75% (more or less) of the maximum recorded during the first application of incremental voltages to the actuator coil 128. This DC voltage level may be used as the baseline voltage level.

Note that different sectors of the disk may be assigned a different baseline voltage, if desired. For example, FIG. 3 illustrates a disk logically divided into 8 sectors 302-316. Each of the sectors could be assigned a different baseline voltage, thereby reducing focus error in each sector. Accordingly, the baseline voltage may include an alternating current component.

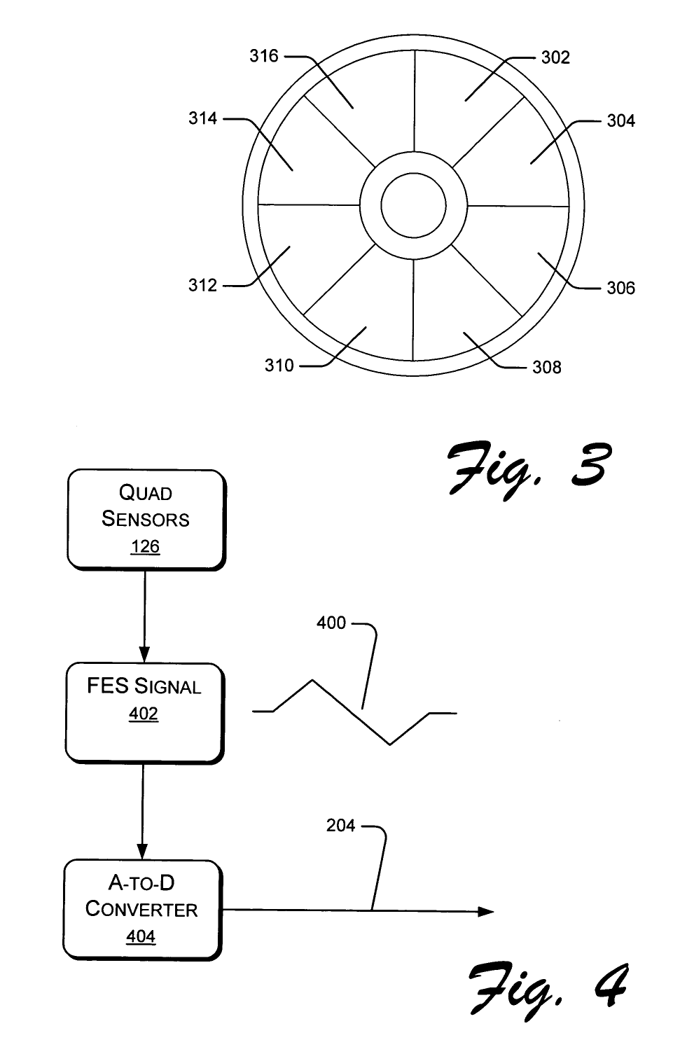

The operation of the quad focus sensors 126 may be better understood by briefly referring to FIG. 4. The quad sensors 126 (previously seen in FIG. 1) are typically optical sensors which respond to a reflection of the laser light 112. The FES (focus error signal) signal 204 is the difference of the sum of the diagonal sensors (i.e. upper left plus lower right, minus upper right plus lower left). An exemplary FES signal 400 is seen to the right of box 402 in FIG. 4. The FES signal is zero where the optics 114-116 are out of focus. As the optics move into focus, the FES signal becomes positive triangle wave. As the optics moves out of focus, the FES signal becomes a negative triangle wave. Note that the FES signal 400 is for illustration purposes only; a real FES signal would contain considerably noisier.

Referring again to FIG. 2, the error term generator 212 is configured to process the FES (focus error signal) signal 402 to create an error term 204 (FIG. 4). In a typical application, an A-to-D converter 404 (FIG. 4) enables the error term generator 212 to translate the FES signal into a digital error term 204. The digital values of the FES signal are suitable for insertion into equations to generate coefficients for Fourier series terms, as will be seen in greater detail below.

An actuator control signal generator 216 generates the signal 202 applied to the actuator focus coil 128. In a practical application, the output of the signal generator 216 is typically a digital value, which is converted to an analog signal via a DAC (digital to analog converter) for coupling to the actuator focus coil 128.

The actuator control signal generator 216 may be configured in a number of ways. In a first embodiment, a coefficient generator 218 is configured to generate coefficients for a Fourier series and a Fourier subroutine 220 is configured to utilize the coefficients generated to generate the signal for application to the actuator focus coil. For example, where a Fourier series having five terms is used, five coefficients could be generated according to:
A0(new)=A0(old)+(DC0*Ek*Mu);
A1(new)=A1(old)+(QS1*Ek*Mu);
B1(new)=B1(old)+(QC1*Ek*Mu);
A2(new)=A2(old)+(QS2*Ek*Mu); and
B2(new)=B2(old)+(QC2*Ek*Mu).

The above equations provide five new coefficients (e.g. A0(new)) using the five previous old coefficients (e.g A0(old)). For example, in one implementation, a new value for each coefficient is calculated 400 times per revolution of the disk 102. (While 400 such calculations per revolution is effective, other rates of calculation could be substituted, depending on application.) As the disk rotates, the error values, Ek, would change 400 times per revolution, as the FES signal was sampled. Additionally, the values for the sinusoidal terms (QS1 through QC2) would change due to a changing angle of rotation of the disk. Note that the initial value of A0 is the baseline value calculated by the baseline actuator positioning routine 210, and the initial values for A1-B2 are zero.

The above equations use A0 to express the coefficient for the non-sinusoidal first term, the nominal DC voltage level (DC0). The terms An and Bn express coefficients for sinusoidal terms “n”, respectively. Terms of the form QS1 or QC2 correspond to a value of the sine or cosine of the first or second harmonic, as indicated, wherein the angle applied to the sinusoidal function is the angle of rotation of the disk (i.e. angular orientation) within the disk within the disk drive. Note that the angle of the sine or cosine is typically multiplied by a scalar, such as 1, 2, etc., so that the coefficients will have different frequency. For example, QS1 might be sin(theta), while QC2 might be cos(2*theta). An adaptation coefficient, Mu, is related to how fast the error coefficient, Ek, is allowed to change the value of the new coefficient. For example, Mu impacts how much change is possible between A1(new) and A1(old).

A Fourier routine 220 is configured to use the coefficients from the coefficient generator 218 and the angle of the disk rotation to produce the actuator control signal 202. The new coefficients may be applied according to the following:
Actuator control signal=(A0*DC0)+(A1*QS1)+(B1*QC1)+(A2*QS2)+(B2*QC2)

In this case QS1 and QC2, for example, are the sine and cosine values, respectively, for the given value of an angle theta and two times theta, respectively, for the first and second harmonic, respectively.

In an alternative implementation, the actuator control signal generator 216 can be implemented without coefficients and a Fourier series. Such a more generalized feed forward scheme could be implemented wherein no-predetermined shape to the feed forward signals is defined. For each bit time, one bit of a sequence that starts at one point in the revolution of the disk and ends when the disk rotates back around to that point again could be stored in memory. Each bit in this sequence would be updated by the least mean squares (LMS) algorithm, but this time the algorithm would be:
Wk(new)=Wk(old)−Mu*Ek

Note that the equations above tend to work well for lower frequency spin rates (e.g. 300 rpm or so of the disk 102) and lower sample rates. Lower disk spin rates and sample rates tend to result in motion of the actuator that is below the actuator's resonant frequency. However, the resonant frequency of the actuator may result in a failure of focus to converge at higher disk speeds (i.e. higher disk rpm) and higher sample rates. That is, the resonant frequency of the actuator must be taken into account at higher disk spin rates; otherwise the input to the actuator will not result in the output expected, i.e. output which will result in movement of the optics to converge on a focal point. In the case of the Fourier series-based implementation, if the spindle speed increases to where the first, second or third harmonics of the once around are above the first suspension resonance of the focus actuator (at about 45 Hz) or if higher harmonics are to be used, then the value of the sine or cosine wave that is multiplied by the Ek*Mu products will also need to be phase shifted by the value of the response of the actuator to that input. Such a phase shift of terms within the actuator control signal will reduce actuator resonance. For example: A1(new)=A1(old)+(QS1(theta)*Ek*Mu), where QS1(theta) equals QS1 phase shifted by the phase shift of the actuator at the frequency of QS1. As seen in the equation above, the phase of terms within the actuator control signal are shifted to the degree necessary compensate for actuator harmonics (e.g. an actuator resonant frequency). This may be necessary if an angular disk speed of the optical disk drive is sufficiently high. For example, exemplary disk speed (rpm) could be associated with a degree to which the actuator control signal is phase-shifted. The degree of the phase shift applied would generally have to be determined by experimentation on the actuator available. Accordingly, a table could associate disk speed rpm with a phase-shift of the actuator control signal.

For the case of the more generalized, non-Fourier Series implementation, compensation for the actuator resonance may be necessary if the sample rate exceeds the frequency of the resonance. This can be done by filtering the Ek values with a digital filter model of the inverse of the actuator frequency response before adapting each Wk. By passing the Ek values through the inverse filter function before applying to the adaptation algorithm. Wk(new)=Wk(old)−Mu*Ek, the effects of the actuator resonance are essentially cancelled.

Other alternatives to the above method of handling the issue of actuator resonant frequency exist. For example, the Filtered X approach, known in algorithms related to adaptive LMS (least mean squares) filtering, could be utilized.

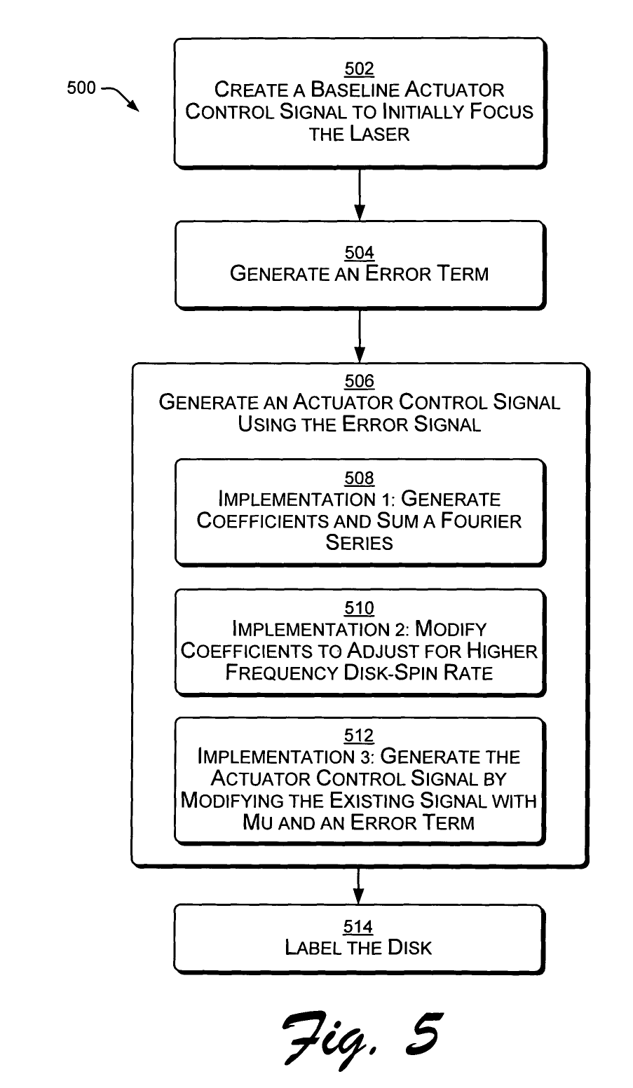

The flowchart of FIG. 5 illustrates a further exemplary implementation, wherein a method 500 is employed to focus the optics of an optical disk drive 100. The elements of the method may be performed by any desired means, such as by the execution of processor-readable instructions defined on a processor-readable media, such as a disk, a ROM or other memory device or by operation of an application specific integrated circuit (ASIC) or other hardware device. In one implementation, the ROM may contain the firmware 132 of FIG. 1, thereby implementing the feed forward engine 200 of FIG. 2 according to a method such as the exemplary method as seen in the flow chart of FIG. 5. In an alternative implementation, an ASIC may contain logic which implements the feed forward engine 200. Also, actions described in any block may be performed in parallel with actions described in other blocks, may occur in an alternate order, or may be distributed in a manner which associates actions with more than one other block.

At block 502, a baseline actuator control signal is generated. The baseline actuator control signal, when applied to the actuator focus coil 128, results in the laser focusing sufficiently that the SUM and FES signals obtained from the quad focus sensors 126 are non-zero. The baseline actuator control signal may be generated in a number of ways. For example, the first exemplary implementation of the baseline actuator positioning routine 210, described above, may be utilized. Recall that in that method, the baseline actuator signal was generated by assumptions made as to the location of the at-rest focal point and the signal required for application to the actuator focus coil 128 to move the focal point to the surface 106 of the disk 102. Alternatively, the second exemplary implementation of the baseline actuator positioning routine 210, described above, may be utilized. Recall that in that method, a range of voltages was applied to the actuator focus coil 128 and the SUM and/or FES signal was monitored. A signal applied to the focus actuator coil 128 associated with a near optimal value of the SUM and/or FES signal could be utilized. Alternatively by stepping the voltage applied to the actuator coil 128, a baseline voltage could be selected from the stepped voltage level when the SUM signal was near the high SUM value.

At block 504, an error term is generated. The error term may be generated by the error term generator 212, using the FES (focus error signal), as seen above. The FES signal is converted into a digital value, which may be used as the error term.

At block 506, an actuator control signal 202 is generated using the error term and other terms. In particular, the actuator control signal 202 may be generated by the actuator control signal generator 216 of the feed forward engine 200. A number of exemplary, alternative and/or complementary implementations of the method by which the actuator control signal 202 is generated are shown in blocks 508-512. In an implementation at block 508, coefficients are generated and a Fourier series is summed. As seen above, a coefficient generator 216 can generate coefficients for use in a Fourier series. The Fourier subroutine 220, using the coefficients and a value for the angle of the disk orientation 206, determines the actuator control signal 202. This actuator control signal, which has been updated via the coefficient generator 216, becomes the new baseline signal for the next adaptation cycle.

In an optional implementation seen in block 510, where the spin-rate of the disk is high enough to interact with the suspension resonance of the actuator coil, the coefficient generator 218 can be modified to compensate for the interaction. This optional implementation was discussed with reference to the coefficient generator 218, in the discussion of FIG. 2, above.

In a further optional implementation seen at block 512, the actuator control signal generator 216 can be implemented without Fourier coefficients and without a Fourier series. As seen above, such a generalized feed forward scheme could be implemented wherein no predetermined shape to the feed forward signals is defined.

At block 514, a label image is applied to the label surface 106 of the disk 102. As the disk turns, the feed forward engine 200 continuously provides an actuator control signal 202 to the focus actuator coil 128, enabling the optics 114 to maintain the focus of the laser 116 on the surface of the disk. The laser beam 112 then applies an image to the coating on the surface 106 of the disk 102.

Although the above disclosure has been described in language specific to structural features and/or methodological steps, it is to be understood that the appended claims are not limited to the specific features or steps described. Rather, the specific features and steps are exemplary forms of implementing this disclosure. For example, while actions described in blocks of the flow diagrams may be performed in parallel with actions described in other blocks, the actions may occur in an alternate order, or may be distributed in a manner which associates actions with more than one other block. And further, while elements of the methods disclosed are intended to be performed in any desired manner, it is anticipated that computer- or processor-readable instructions, performed by a computer and/or processor, typically located within a firmware 132, reading from a computer- or processor-readable media, such as a ROM, disk or CD ROM, would be preferred, but that an application specific gate array (ASIC) or similar hardware structure, could be substituted.

1. A system for providing a signal to an actuator within an optical disk drive, to focus optics on an optical disk within the optical disk drive, wherein the system comprises:
an error term generator configured to generate an error term;
an adaptation coefficient configured to regulate a rate at which the error term modifies an actuator control signal; and
an actuator control signal generator to generate the actuator control signal, wherein the actuator control signal is a function of a prior actuator position, the error term and the adaptation coefficient.

2. The system of claim 1, wherein the error term generator is configured to generate the error term using a FES signal as input.

3. The system of claim 2, wherein the error term generator is configured to sample the FES signal and use an A-to-D converter to produce the error term.

4. The system of claim 1, wherein the error term generator is configured to calculate the error term for every new actuator control signal generated by the actuator control signal generator.

5. The system of claim 1, wherein the actuator control signal generator additionally comprises:
a coefficient generator to generate coefficients as a function of inputs comprising the adaptation coefficient and the error term; and
a Fourier subroutine to generate the actuator control signal using the coefficients generated.

6. The system of claim 1, wherein the actuator control signal generator additionally comprises:
a coefficient generator configured to generate coefficients comprising:
A0=A0+(DC0*Ek*Mu);
A1=A1+(QS1*Ek*Mu);
B1=B1+(QC1*Ek*Mu);
A2=A2+(QS2*Ek*Mu);
B2=B2+(QC2*Ek*Mu); and
wherein Ek is the error term and Mu is the adaptation coefficient; and
a Fourier subroutine configured to generate the actuator control signal using the coefficients generated.

7. The system of claim 1, wherein the actuator control signal generator is configured to generate a signal according to Wk(new)=Wk(old)−(Mu*Ek), wherein Ek is the error term and Mu is the adaptation coefficient.

8. The system of claim 7, wherein the actuator signal generator is configured, at disk rpm high enough to result in actuator resonance, to filter Ek values with a digital filter model of an inverse of the actuator frequency response before adapting each Wk.

9. The system of claim 1, wherein the actuator control signal generator is configured, if an angular disk speed of the optical disk drive is sufficiently high, to shift a phase of terms within the actuator control signal to reduce actuator resonance.

10. The system of claim 1, additionally comprising a baseline actuator positioning routine to set a baseline voltage level.

11. The system of claim 1, wherein the baseline voltage level includes an AC component.

12. The system of claim 1, additionally comprising a baseline actuator positioning routine, to establish a baseline signal for application to an actuator, wherein the baseline actuator positioning routine is configured to:
step an actuator through a full range of focus;
record a maximum value of the SUM signal data obtained within the full range of focus; and
set the baseline signal according to an input to the actuator which resulted in close to the maximum value of the SUM signal data.

13. The system of claim 12, wherein the input to the actuator which resulted in close to the maximum value of the SUM signal data is set to approximately 75% of the maximum value.

14. A processor-readable medium comprising processor-executable instructions for focusing optics within an optical disk drive, the processor-executable instructions comprising instructions for:
generating an error term;
regulating a rate at which the error term modifies an actuator control signal using an adaptation coefficient; and
generating an actuator control signal as a function of a prior actuator position, the error term and the adaptation coefficient.

15. The processor-readable medium of claim 14, comprising processor-executable instructions for generating the error term using a FES signal as input.

16. The processor-readable medium of claim 15, comprising processor-executable instructions for sampling the FES signal and using an A-to-D converter to produce the error term.

17. The processor-readable medium of claim 14, comprising processor-executable instructions for calculating the error term for every new actuator control signal generated by the actuator control signal generator.

18. A processor-readable medium as recited in claim 14, wherein generating the actuator control signal comprises instructions for:
generating coefficients as a function of inputs comprising the adaptation coefficient and the error term; and
calculating a Fourier series to generate the actuator control signal using the coefficients generated.

19. A processor-readable medium as recited in claim 14, wherein generating the actuator control signal comprises instructions for:
generating coefficients comprising:
A0=A0+(DC0*Ek*Mu);
A1=A1+(QS1*Ek*Mu);
B1=B1+(QC1*Ek*Mu);
A2=A2+(QS2*Ek*Mu); and
B2=B2+(QC2*Ek*Mu);
wherein Ek is the error term and Mu is the adaptation coefficient; and
calculating a Fourier series to generate the actuator control signal using the coefficients generated.

20. A processor-readable medium as recited in claim 14, wherein generating the actuator control signal comprises instructions for calculating the actuator control signal according to Wk(new)=Wk(old)−(Mu*Ek), wherein Ek is the error term and Mu is the adaptation coefficient.

21. A processor-readable medium as recited in claim 20, wherein generating the actuator control signal comprises instructions for, if an angular disk speed of the optical disk drive is sufficiently high, shifting a phase of terms within the actuator control signal to compensate for actuator harmonics.

22. A processor-readable medium as recited in claim 14, comprising instructions for creating a baseline signal.

23. The processor-readable media of claim 22, additional comprising instructions for creating a baseline signal, wherein the baseline signal is different in different sectors of the disk.

24. A processor-readable medium as recited in claim 14, wherein creating the baseline signal to initially position an actuator comprises instructions for:
step an actuator through a full range of focus;
record a maximum value of the SUM signal data obtained within the full range of focus; and
set the baseline signal according to an input to the actuator which resulted in close to the maximum value of the SUM signal data.

25. A method of focusing optics on a disk within an optical disk drive, comprising:
generating an error term;
regulating a rate at which the error term modifies an actuator control signal using an adaptation coefficient; and
generating an actuator control signal as a function of a prior actuator position, the error term and the adaptation coefficient.

26. The method of claim 25, additionally comprising generating the error term using a FES signal as input.

27. The method of claim 25, additionally comprising sampling the FES signal and using an A-to-D converter to produce the error term.

28. The method of claim 25, additionally comprising calculating the error term for every new actuator control signal generated by the actuator control signal generator.

29. The method of claim 25, wherein generating the actuator control signal comprises:
generating coefficients as a function of inputs comprising the adaptation coefficient and the error term; and
calculating a Fourier series to generate the actuator control signal using the coefficients generated.

30. The method of claim 25 wherein generating the actuator control signal comprises:
generating coefficients comprising:
A0=A0+(DC0*Ek*Mu);
A1=A1+(QS1*Ek*Mu);
B1=B1+(QC1*Ek*Mu);
A2=A2+(QS2*Ek*Mu); and
B2=B2+(QC2*Ek*Mu);
wherein Ek is the error term and Mu is the adaptation coefficient; and
calculating a Fourier series to generate the actuator control signal using the coefficients generated.

31. The method of claim 25, additional comprising creating a baseline signal for initial use as the actuator control signal.

32. The method of claim 25, wherein creating the baseline signal to initially position an actuator comprises:
stepping an actuator through a full range of focus;
recording a maximum value of the SUM signal data obtained within the full range of focus; and
setting the baseline signal according to an input to the actuator which resulted in close to the maximum value of the SUM signal data.

33. The method of claim 25, wherein generating the actuator control signal comprises calculating the actuator control signal according to Wk(new)=Wk(old)−(Mu*Ek), where Mu is the adaptation coefficient and Ek is the error term.

34. The method of claim 25, wherein generating the actuator control signal additionally comprising, if an angular disk speed of the optical disk drive is sufficiently high, shifting a phase of terms within the actuator control signal to compensate for actuator harmonics.

35. A focusing system, comprising:
means for generating an error term;
means for regulating a rate at which the error term modifies an actuator control signal using an adaptation coefficient; and
means for generating an actuator control signal as a function of a prior actuator position, the error term and the adaptation coefficient.

36. The focusing system of claim 35, additionally comprising means for generating the error term using a FES signal as input.

37. The focusing system of claim 35, additionally comprising means for sampling the FES signal and using an A-to-D converter to produce the error term.

38. The focusing system of claim 35, additionally comprising means for calculating the error term for every new actuator control signal generated by the actuator control signal generator.

39. The focusing system of claim 35, wherein the means for generating the actuator control signal comprises:
means for generating coefficients as a function of inputs comprising the adaptation coefficient and the error term; and
means for calculating a Fourier series to generate the actuator control signal using the coefficients generated.

40. The focusing system of claim 35, wherein the means for generating the actuator control signal comprises:
means for generating coefficients comprising:
A0=A0+(DC0*Ek*Mu);
A1=A1+(QS1*Ek*Mu);
B1=B1+(QC1*Ek*Mu);
A2=A2+(QS2*Ek*Mu); and
B2=B2+(QC2*Ek*Mu);
wherein Ek is the error term and Mu is the adaptation coefficient; and
means for calculating a Fourier series to generate the actuator control signal using the coefficients generated.

41. The focusing system of claim 35, wherein the means for generating the actuator control signal comprises means for calculating the actuator control signal according to Wk(new)=Wk(old)−(Mu*Ek), wherein Ek is the error term and Mu is the adaptation coefficient.

42. The focusing system of claim 41, wherein the means for generating the actuator control signal additionally comprises, if an angular disk speed of the optical disk drive is sufficiently high, means for shifting a phase of terms within the actuator control signal to compensate for actuator harmonics.

43. The focusing system of claim 35, additional comprising means for creating a baseline signal, wherein the baseline signal is different in different sectors of the disk.

44. The focusing system of claim 35, wherein creating the baseline signal to initially position an actuator comprises:
means for stepping the actuator through a full range of focus;
means for recording a maximum value of the SUM signal data obtained within the full range of focus; and
means for setting the baseline signal according to an input to the actuator which resulted in close to the maximum value of the SUM signal data.
